(19) United States
(12) Patent Application Publication
(10) Pub. No.: US 2025/0148309 A1
(43) Pub. Date: May 8, 2025

(54) SYSTEM AND METHOD FOR ESTABLISHING RELATIONSHIPS BETWEEN DATA ELEMENTS

(71) Applicant: EATON INTELLIGENT POWER LIMITED, Dublin (IE)

(72) Inventors: Adi BOTEA, Dublin (IE); Karthikeyan Sundararajan CHOKAPPA, Pune (IN); Anup KUMAR, Satna (IN); Tony MARRERO, Dublin (IE); Rhythm MEHRA, Amritsar (IN); Srimaya PADHI, Pune (IN)

(21) Appl. No.: 18/833,479

(22) PCT Filed: Mar. 23, 2022
(86) PCT No.: PCT/EP2022/057704

§ 371 Date: Jul. 26, 2024

(30) Foreign Application Priority Data
Jan. 29, 2022 (IN) 202211004941

(51) Int. Cl. G06N 5/022

(52) U.S. Cl. CPC G06N 5/022

(57) ABSTRACT

Some embodiments are directed to a computer implemented system and method to determine relationships between data elements using a knowledge graph are described. The method comprises establishing a knowledge graph having graph elements, associating weights with data elements and determining at least some of these weights to be modifiable weights. Training data is used to determine the relationships between data elements in the knowledge graph by calculating the strength of the relationship. The calculated relationship strength values are compared to previously established relationship strength values, and one or more modifiable weights are modified to reduce the error between the calculated and established relationship strength values. These steps are repeated until a matching criterion is reached.

### CROSS-REFERENCE TO RELATED APPLICATIONS

This application is a national phase filing under 35 C.F.R. § 371 of and claims priority to PCT Patent Application No. PCT/EP2022/057704, filed on Mar. 23, 2022, which claims the priority benefit under 35 U.S.C. § 119 of Indian Patent Application No. 202211004941, filed on Jan. 29, 2022, the contents of which are hereby incorporated in their entireties by reference.

### TECHNICAL FIELD

The present description generally relates to the technical field of artificial intelligence and measurement methods, and it relates in particular to knowledge graphs used for recommendations.

### BACKGROUND

The present disclosure relates to a computer implemented system and methods to determine relationships between data elements using a knowledge graph.

In knowledge representation and reasoning, a knowledge graph is a knowledge base that uses a graph-structured data model to integrate data. Knowledge graphs are used to store and process interlinked descriptions on edges, known as the relationships between nodes.

A social network can be seen as an analogy for a knowledge graph as social networks encode entities such as people. For example, two individuals can be connected through relations such as a friend, and these relations are known as edges. The knowledge graph encodes their contents in a similar connected manner through the means of nodes for entities and edges for relations between two entities, but unlike a social network, the knowledge graphs are not required to encode knowledge focused on people.

By analysing existing edges in a graph, new subtle relations in the graph can be discovered. For example, two individuals with ten common friends may benefit from the recommendation of becoming friends. Carrying out this type of reasoning using artificial intelligence techniques can require assigning weights to different types of relationships, such as a friend or colleague, as each relationship can have a different relevance to the problem at hand. Therefore, assigning accurate weights to different types of relationships can greatly impact the accuracy of the recommendations.

### SUMMARY OF DISCLOSURE

According to one aspect of the present disclosure, a computer-implemented method to determine relationships between data elements in a data store where the data is obtained from multiple information sources is disclosed. In this disclosure, we address the problem of assigning weights in order to increase customisability of a knowledge graph. The method includes establishing a knowledge graph, having graph elements including a plurality of nodes representing data elements and a plurality of edges, wherein each edge joins two nodes in the plurality of nodes and represents a strength of relationship between said two nodes and includes associating weights with graph elements, and determining at least some of said weights as modifiable weights. This method also includes using training data comprising established relationship strength values between pairs of nodes, determining relationships between pairs of nodes by establishing a set of qualifying paths between each pair of nodes. Once the qualifying paths have been established, the strength of the relationship between the pair of nodes is determined by summing weights associated with each qualifying path in the set of qualifying paths to calculate a relationship strength value for the edge between the pair of nodes. Then, the established relationship strength values are compared with the calculated relationship strength values and one or more of the modifiable weights are modified so that the established relationship strength values match the calculated relationship strength values. Steps to calculate the relationship strength values and modifying modifiable weights are repeated until a matching criterion is reached. The relationship strengths are then established between data elements in the data store in accordance with the relationship strength calculated between the nodes representing those data elements.

As paths beyond a given length tend to lose their importance, the method may further include qualifying paths comprising as a qualifying parameter a cut-off condition wherein there is a beneficial trade-off between computational time and the importance of paths as well as qualifying paths comprising as a qualifying parameter a filter wherein pathways are filtered away that match one or several irrelevance pattens. It should be noted that the qualifying parameters are specified as input during initialization.

In some embodiments, the calculated relationship strength values are dependent on the modifiable weights that characterise the graph elements. The modifiable weights are then adjusted to reduce the error between the calculated relationship strength values and the established relationship strength values recorded in the training data. This method further includes the matching criterion which is only satisfied when the changes in the modifiable weights become smaller than a predefined threshold.

In a second aspect, this disclosure provides a method of selecting a manufacturing resource for manufacturing a product, wherein the method comprises a computer-implemented method of determining relationships between data elements according to the first aspect. The data elements relate to the manufacturing of products using a set of manufacturing resources, and the method comprises determining relationship strengths between first nodes representing the manufacturing resources in the set of manufacturing resources and a second node representing a product, wherein the resulting relationship strengths between the first nodes and the second node are ranked to order manufacturing resources for the product.

A third aspect of this disclosure includes a corresponding system to determine relationships between data elements comprising data obtained from multiple information sources. The system includes one or more connections that provide access to multiple data sources comprising the data elements, and computing apparatus comprising at least a memory and a processor. The processor is programmed to establish a knowledge graph having graph elements including a plurality of nodes each representing one of the data elements and a plurality of edges, wherein each edge joins two nodes in the plurality of nodes and represents a strength of relationship between said two nodes. The system also includes weights associated with graph elements, wherein some of said weights are modifiable weights and training data comprising established relationship strength values between pairs of nodes, wherein the training data is used to determine relationships between pairs of nodes. To determine relationships between pairs of nodes with an edge between them, a set of qualifying paths is established and a strength of relationship between the pair of nodes is determined by summing weights associated with each qualifying path in the set of qualifying paths to calculate the relationship strength value of the edge between the pair of nodes. The established relationship strength values are then compared to the calculated relationship strength values and one or more of the modifiable weights are modified so that the established relationship strength values match the calculated relationship strength values. The steps of calculating relationship strength values and modifying modifiable weights are repeated until the matching criterion is reached. Resulting relationship strengths are established between data elements in the data store in accordance with the relationship strength calculated between the nodes representing those data elements.

This system also includes one or more connections to data sources comprising at least one database in the memory of the system. The one or more connections to data sources comprise at least one connection via an API to an external system.

In a fourth aspect, the disclosure provides a system for selecting a manufacturing resource for manufacturing a product, wherein the system comprises a system for determining relationships between data elements according to the third aspect, wherein the data elements relate to manufacturing of products using a set of manufacturing resources. The system is programmed to determine relationship strengths between first nodes representing the manufacturing resources in the set of manufacturing resources and a second node representing a product. Furthermore, the resulting relationship strengths between the first nodes and the second node are ranked to order manufacturing resources for the product.

This is a challenging problem as knowledge graphs can be large, and the calculation of the relationship strength needs to be accurate and consistent throughout the graph. One context in which this problem is relevant is in the manufacturing of machine parts. In practice, it is difficult to determine how best to assign parts for printing using 3D printing devices, where several 3D printing devices can be available—for example, 3D printing devices in the network of an organisation, or in a farm of 3D printing devices. There may even be a choice as to whether the parts could be sourced by another manufacturing route. Currently, 3D printing farm technologies are unable to make an accurate decision about whether it is faster or more efficient to print parts in-house or outsource to an external supplier.

### BRIEF DESCRIPTIONS OF DRAWINGS

Specific embodiments of the disclosure will now be described, by way of example, with reference to the accompanying drawings of which:

FIG. 1 is an overview of a system according to an embodiment of the disclosure;

FIG. 2 is a flowchart summarizing a method according to an embodiment of the disclosure to determine relationships between data elements in a data store where the data is obtained from multiple information sources;

FIG. 3 is a flowchart for initializing the training dataset;

FIG. 4 is a flowchart for training the dataset;

FIG. 5 is a flowchart for calculating the strength of relationship between the pair of nodes;

FIG. 6 is a flowchart for adjusting the modifiable weights; and

FIG. 7 is a flowchart for updating the system.

### DESCRIPTION OF EMBODIMENT

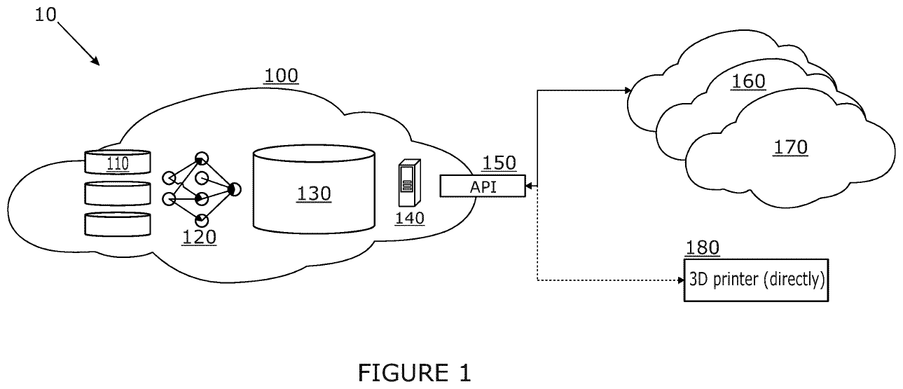

FIG. 1 shows the overview of the system (10). The system includes one or more connections to data sources, the one or more connections providing access to multiple data sources (110) comprising at least one database (130) in the memory of the system (10). The system (10) also includes a processor programmed to establish a knowledge graph (120), a server (140) that exposes the outputs of a knowledge graph tuning process (100), and an API (150) in communication with manufacturing environments (160) and third-party environments (170) or 3D printing devices (180). The system (10) carries out the knowledge graph tuning process (100) to determine relationships between data elements in a data store (130) where the data is obtained from multiple information sources (110). The knowledge graph (120) has graph elements built on top of existing databases (110) that connects data together. The knowledge graph elements are represented by entities as nodes and connections across entities as edges, wherein the edges connect a pair of nodes and capture the relationship of interest between them. The database (130) is used to store the knowledge graphs (120), models, training, and meta data as well as the weights to the knowledge graphs (120). The weights are associated with graph elements and some of the weights are modifiable parameters can transform the input data during training. In this disclosure, training is an iterative process, where the training in each iteration establishes a relationship strength value between each pair of nodes. Once the training has reached a matching criterion such as when the changes in weights become smaller than a predefined threshold, the outputs of the knowledge graph tuning process (100) are sent to a server (140).

The server (140) communicates with an API (150), exposing the data outputs to 3D printing devices (180) and environments in the cloud. In this embodiment, the API (150) is in communication with manufacturing environments (160), third-party environments (170) and 3D printing devices (180). The embodiment described here is of particular value in determining the best approach to providing a component—in particular, whether it is sourced through a manufacturer or some other supplier, or directly 3D printed internally. This is however only one of many possible applications for the approach described here, and other embodiments may relate to other decision-making processes.

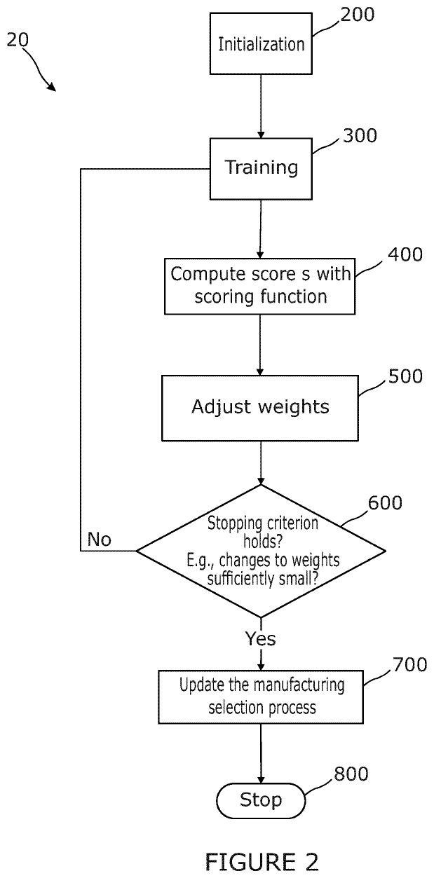

In FIG. 2, a flowchart summarizes a method to determine relationships between data elements in a data store where the data is obtained from multiple information sources. At block (200), the knowledge graph is established. This has graph elements including a plurality of nodes representing data elements and a plurality of edges, wherein each edge joins two nodes in the plurality of nodes and represents a strength of relationship between said two nodes. At block (300), training data comprising established relationship strength values between pairs of nodes is used to determine the relationships between pairs of nodes, this process establishing a set of qualifying paths between the pair of nodes. Next, at block (400), a strength of relationship between the pair of nodes is calculated by summing weights associated with each qualifying path in the set of qualifying paths to calculate a relationship strength value for the edge between the pair of nodes. The established relationship strength values are compared with the calculated relationship strength values, and in block (500), one or more of the modifiable weights are modified so that the established relationship strength values match the calculated relationship strength values. If the matching criterion is reached at block (600), then the training process ends. However, if the matching criterion does not hold, another iteration of training is carried out at block (300). When the training process is complete at block (300), the manufacturing selection process and selection API are updated at block (700) and the pairs of nodes are ranked. Lastly, the data store is updated with the newly ranked pairs of nodes and the process ends at block (800).

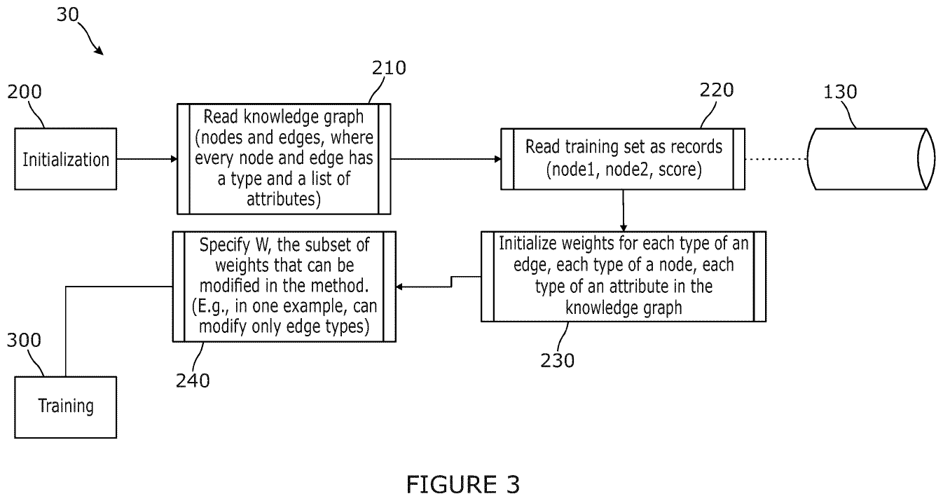

Referring to FIG. 3, a flowchart describes an initialization process (30) of the training dataset. At block (200) the knowledge graph (120) having graph elements comprising the plurality of nodes representing data elements, the plurality of edges and a list of zero or more attributes for each node and edge is initialized. The nodes of the graph are also known as entities, and each edge of the plurality of edges joins two nodes in the plurality of nodes and represents a strength of relationship between said two nodes.

The training dataset comprising of nodes and established relationship strength values between the nodes is also initialized at block (200). Once the knowledge graph (120) and training dataset have been defined, they are read into the system at blocks (210) and (220) from the data store (130). The weights associated with the nodes and edges are then initialized at block (230) and a subset of these weights are modified at block (240). For example, in one embodiment, only the edge types can be modified. The modifiable weights for each type of edge, node, and attribute in the knowledge graph (120) are parameters that can transform the input data during training.

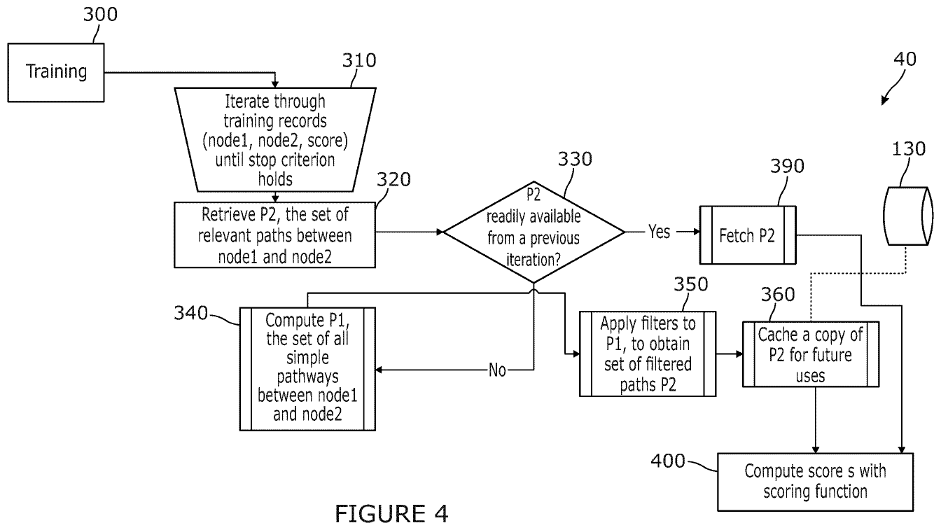

In FIG. 4, a training process (40) is carried out in an iterative process. The training block (300) is a series of manual iterations (310), with each iteration (310) using training data comprising established relationship strength values between pairs of nodes and determining the relationships between pairs. These relationship strength values are presented to the graph, one by one, and the values of the modifiable weights are adjusted in each iteration. It should be understood that the relationship strength value does not require nodes to be connected by a direct edge, and as such, the iterative training will adjust the modifiable weights of the types of edges captured in a set of paths between the nodes in the graph.

During the training process (40), the set of relevant qualifying paths between nodes that satisfies a cut-off condition is retrieved at block (320). If the qualifying path is readily available from the previous iteration at block (330), it is fetched at block (390). These qualifying paths can be computed on the fly or obtained from a cache if available. In one possible embodiment, the set of qualifying paths can be computed at block (340) during the first iteration when a given relationship strength value is processed. In order to compute the set of qualifying paths, the following sub-steps can be followed: first, the cut-off condition should be met. This is a beneficial trade-off between the computational time and the importance of the qualifying paths, and in this embodiment could be denoted as avoiding generating paths longer than a given threshold. In practice, paths beyond a given length tend to lose their importance. For example, in a social network, a short path such as one-hop path: “John is a friend of Mark” suggests a much stronger relationship than a multiple-hop path such as “John is a friend of a friend of a friend of Peter”. Once the cut-off condition has been met, qualifying paths are further reduced through filtering means at block (350) in order to remove information that is irrelevant to the application. This is performed by using one or several given patterns and filtering away pathways that match such a pattern. After filtering the paths, a cache of the final set of qualifying paths is generated for future uses at block (360). It should be understood that parameters such as the cut-off threshold and the set of irrelevance patterns need to be specified as input.

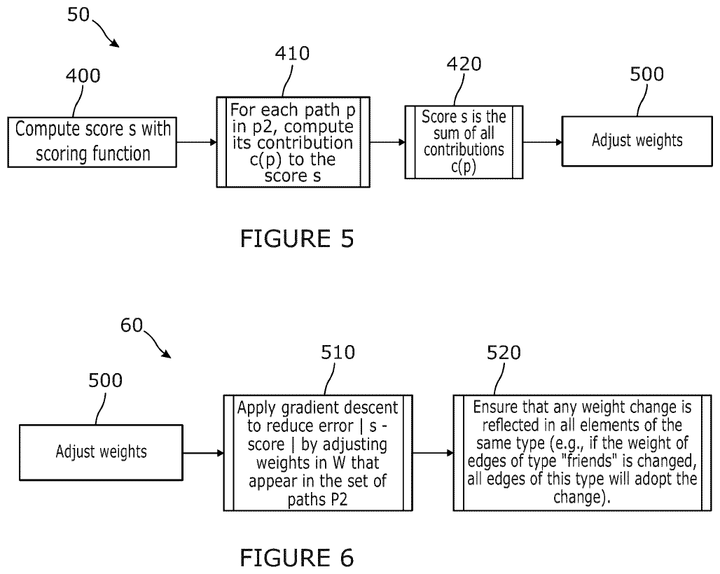

In FIG. 5, the relationship strength values are calculated between the nodes for each set of qualifying paths at block (400) during a strength calculation process (50). It should be understood that the calculated relationship strength values depend on the modifiable weights that characterize the graph elements such as edges contained in the set of paths. In one possible embodiment, the calculated relationship strength value for the edge between the pair of nodes is determined by the strength between the pair of nodes at block (410). This is calculated by summing the scores associated with each qualifying path in the set of qualifying paths at block (420). An individual qualifying path score should take the weights into account and capture the heuristic that the shorter the path, the stronger the score. For example, in this embodiment the smaller weights represent a more important type of edge, so the cost of each path is the sum of the weights of the edges in each path.

Referring to FIG. 6, the weights of the graph elements are adjusted at block (500) during a weight adjustment process (60). The weights in the set of qualifying paths are adjusted to reduce the error between the established relationship strength values and the calculated relationship strength values by applying a gradient descent at block (510). In this step, the established relationship strength values are compared to the calculated relationship strength values and one or more of the modifiable weights are modified so that the established relationship strength values match the calculated relationship strength values at block (520). It should be understood that any weight change must be reflected in all elements of the same type. For example, if the weight of the edges of type “friend” is changed, all edges of this type should adopt this change too. In a preferred embodiment, all elements of a given type have the same weight. This allows the method to scale to the entire graph, as knowledge graphs (120) can be large, but the number of different types of elements such as types of relationships, is much smaller in comparison.

However, in practice not all elements of the same type have the same weight. That is, a given element such as a weight can have two weights, one corresponding to its type, and one corresponding to the element at hand. For instance, the weight of the type is the weight of the friend relationship, and the weight of the element is the weight that two friends who interact very often could have a stronger relationship than two friends who hardly interact. This disclosure focuses on tuning type-specific weights and allows the combination with element weights.

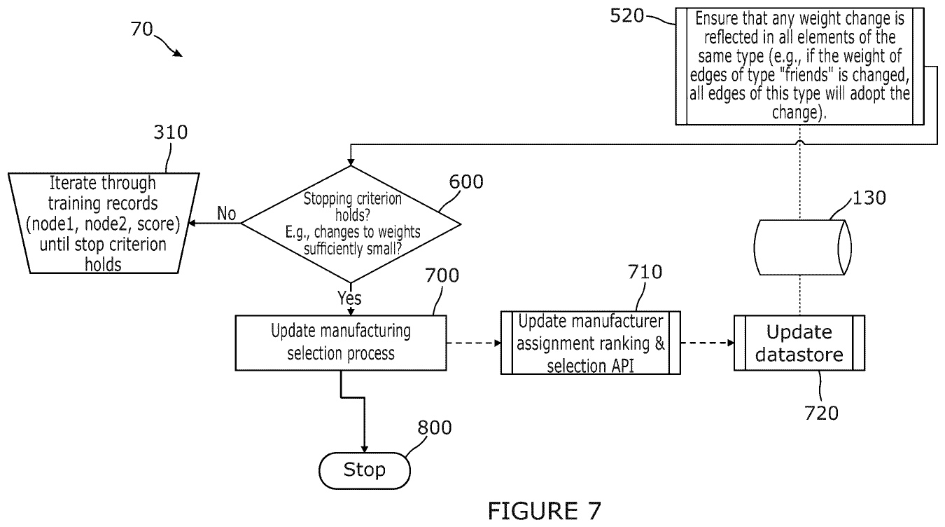

Lastly, in FIG. 7, a decision is made as to whether the matching criterion is implemented on the training iterations or not at block (600) in a matching criterion process (70). If the matching criterion holds, the training process ends. However, if the matching criterion does not hold, another iteration of training is carried out at block (310). An example in one possible embodiment could be that the criterion is satisfied when the changes in the weights become smaller than a predefined threshold.

This embodiment could be used for a number of different purposes. For instance, this approach is useful in manufacturing, particularly in the supplier and 3D printing space where manufacturing resources need to be selected for the manufacturing of products. This process includes automatically assigning parts from highly ranked suppliers to print products using 3D printing devices where there can be several 3D printing devices available. This is advantageous as it can make accurate decisions about whether it is faster or more efficient to print parts in-house or outsource to an external supplier.

Once the training process is complete, the manufacturing selection process and selection API are updated at blocks (700) and (710) respectively by ranking the options with the tuned knowledge graph. Pairs of nodes are ranked based on their calculated relationship strength values, wherein the highest ranked pair can automatically identify which supplier to choose that will result in the best outcome based on criteria such as cost, quality, reliability, or a plurality of other factors. Lastly, the data store (130) is updated with the newly ranked pairs of nodes at block (720) and the process ends at block (800).

The skilled person will appreciate that further embodiments may be provided within the spirit and scope of the presently disclosed subject matter as claimed—these may, for example, relate to decision-making processes other than manufacture of components.

1. A computer-implemented method to determine relationships between data elements in a data store where the data is obtained from multiple information sources, the method comprising;
establishing a knowledge graph having graph elements including a plurality of nodes representing data elements and a plurality of edges, wherein each edge joins two nodes in the plurality of nodes and represents a strength of relationship between said two nodes;
associating weights with graph elements, and determining at least some of said weights as modifiable weights;
using training data comprising established relationship strength values between pairs of nodes, determining relationships between pairs of nodes by:
for each pair of nodes with an edge between them, establishing a set of qualifying paths between the pair of nodes, determining a strength of relationship between the pair of nodes by summing weights associated with each qualifying path in the set of qualifying paths to calculate a relationship strength value for the edge between the pair of nodes;
comparing the established relationship strength values with the calculated relationship strength values and modifying one or more of the modifiable weights so that the established relationship strength values match the calculated relationship strength values; and
repeating the steps of calculating relationship strength values and modifying modifiable weights until a matching criterion is reached;
establishing resulting relationship strengths between data elements in the data store in accordance with the relationship strength calculated between the nodes representing those data elements.

2. The method as claimed in claim 1, wherein the qualifying paths comprise as a qualifying parameter a cut-off condition wherein there is a beneficial trade-off between computational time and the importance of paths.

3. The method as claimed in claim 1, wherein the wherein qualifying paths comprise as a qualifying parameter a filter wherein pathways are filtered away that match one or several irrelevance pattens.

4. The method as claimed in claim 2, wherein the qualifying parameters are specified as input during initialization.

5. The method as claimed in claim 1, wherein the calculated relationship strength values are dependent on the modifiable weights that characterize the graph elements.

6. The method as claimed in claim 5, wherein the modifiable weights are adjusted to reduce the error between the calculated relationship strength values and the established relationship strength values recorded in the training data.

7. The method as claimed in claim 1, wherein the matching criterion is satisfied when the changes in the modifiable weights become smaller than a predefined threshold.

8. A method of selecting a manufacturing resource for manufacturing a product, wherein the method comprises a computer-implemented method of determining relationships between data elements as claimed in claim 1, wherein the data elements relate to manufacturing of products using a set of manufacturing resources, and the method comprises determining relationship strengths between first nodes representing the manufacturing resources in the set of manufacturing resources and a second node representing a product, wherein the resulting relationship strengths between the first nodes and the second node are ranked to order manufacturing resources for the product.

9. A system for determining relationships between data elements comprising data obtained from multiple information sources, the system comprising:
one or more connections to data sources, the one or more connections providing access to multiple data sources comprising the data elements; and
computing apparatus comprising at least a memory and a processor, wherein the processor is programmed to:
establish a knowledge graph having graph elements including a plurality of nodes each representing one of the data elements and a plurality of edges, wherein each edge joins two nodes in the plurality of nodes and represents a strength of relationship between said two nodes;
associate weights with graph elements, wherein some of said weights are modifiable weights;
using training data comprising established relationship strength values between pairs of nodes, to determine relationships between pairs of nodes by:
for each pair of nodes with an edge between them, establishing a set of qualifying paths between the pair of nodes, determining a strength of relationship between the pair of nodes by summing weights associated with each qualifying path in the set of qualifying paths to calculate a relationship strength value for the edge between the pair of nodes;
comparing the established relationship strength values with the calculated relationship strength values and modifying one or more of the modifiable weights so that the established relationship strength values match the calculated relationship strength values; and
repeating the steps of calculating relationship strength values and modifying modifiable weights until a matching criterion is reached;
establish resulting relationship strengths between data elements in the data store in accordance with the relationship strength calculated between the nodes representing those data elements.

10. The system of claim 9, wherein the one or more connections to data sources comprise at least one database in the memory of the system.

11. The system of claim 9, wherein the one or more connections to data sources comprise at least one connection via an API to an external system.

12. A system for selecting a manufacturing resource for manufacturing a product, wherein the system comprises a system for determining relationships between data elements as claimed in claim 9, and wherein the data elements relate to manufacturing of products using a set of manufacturing resources, wherein the system is programmed to determine relationship strengths between first nodes representing the manufacturing resources in the set of manufacturing resources and a second node representing a product, wherein the resulting relationship strengths between the first nodes and the second node are ranked to order manufacturing resources for the product.
